(19) United States
(12) Patent Application Publication
(10) Pub. No.: US 2021/0358401 A1
(43) Pub. Date: Nov. 18, 2021

(54) PIXEL UNIT AND DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Shiqi LIU, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/626,531

(22) PCT Filed: Nov. 13, 2019
(86) PCT No.: PCT/CN2019/117882

§ 371 Date: Dec. 25, 2019

(30) Foreign Application Priority Data
Oct. 25, 2019 (CN) 201911022975.3

(51) Int. Cl. G09G 3/3208; G09G 3/20

(52) U.S. Cl. CPC G09G 3/3208; G09G 3/2003; G09G 2300/0452; G09G 2300/0426; G09G 2320/0257; G09G 2300/0852

(57) ABSTRACT

A pixel unit and a display panel are provided. The pixel unit at least includes a first region and a second region. The first region includes at least a first light emitting unit, and the second area includes at least a second light emitting unit. When the pixel unit is in an operating state, one of the first light emitting unit and the second light emitting unit is in a light emitting state.

### FIELD OF INVENTION

This disclosure relates to the field of display technology, and more particularly, to a pixel unit and a display panel having the pixel unit.

### BACKGROUND OF INVENTION

In display technology, organic light emitting diode (OLED) displays have many advantages, such as thinness, self-illumination, short response times, wide viewing angles, full color display, high luminous efficiency, and low power consumption. It has gradually become the third generation display technology after liquid crystal displays (LCD).

As the light emitting time of the display becomes longer, the disadvantages of the OLED display panel gradually emerge. For example, when the display panel emits light for a long time, the OLED elements of the display panel gradually decay, or/and a threshold voltage of a TFT device drifts, resulting in afterimages in the display panel and reducing the quality of the display panel.

Therefore, it is necessary to provide a display panel to solve the above technical problems.

### SUMMARY OF INVENTION

The disclosure provides a pixel unit and a display panel to solve the technical problem of afterimages in the conventional display panel.

In order to solve the above problems, the disclosure provides a technical solution as follows.

The disclosure provides a pixel unit. The pixel unit at least comprises a first region and a second region;

wherein at least a first light emitting unit is disposed in the first region;

at least a second light emitting unit is disposed in the second region; and

wherein when the pixel unit is in an operating state, one of the first light emitting unit and the second light emitting unit is in a light emitting state.

In the pixel unit of the disclosure, the first region further comprises a first driving circuit, and the first driving circuit is electrically connected to the first light emitting unit; the second region further comprises a second driving circuit, and the second driving circuit is electrically connected to the second light emitting unit. When the pixel unit is in the operating state, the first driving circuit is configured to drive the first light emitting unit to emit light, or the second driving circuit is configured to drive the second light emitting unit to emit light.

In the pixel unit of the disclosure, the first driving circuit at least comprises a first thin film transistor, a second thin film transistor, and a first storage capacitor; the second driving circuit at least comprises a third thin film transistor, a fourth thin film transistor, and a second storage capacitor. The first thin film transistor, the second thin film transistor, the third thin film transistor, and the fourth thin film transistor are one of a P-type transistor or an N-type transistor. A transistor type of the fourth thin film transistor is different from transistor types of the first thin film transistor, the second thin film transistor, and the third thin film transistor.

In the pixel unit of the disclosure, a gate of the first thin film transistor is electrically connected to a scanning signal line, a source/drain of the first thin film transistor is electrically connected to a data signal line, and a drain/source of the first thin film transistor is electrically connected to a first electrode plate of the first storage capacitor and a gate of the second thin film transistor; a source/drain of the second thin film transistor is electrically connected to an input terminal of the pixel unit, and a drain/source of the second thin film transistor is electrically connected to a second electrode plate of the first storage capacitor and the first light emitting unit. A gate of the third thin film transistor is electrically connected to a scanning signal line, a source/drain of the third thin film transistor is electrically connected to a data signal line, and a drain/source of the first thin film transistor is electrically connected to the first electrode plate of the second storage capacitor and the gate of the second thin film transistor; a source/drain of the fourth thin film transistor is electrically connected to the input terminal of the pixel unit and is electrically connected to the second electrode plate of the second storage capacitor, and a drain/source of the fourth thin film transistor is connected to the second light emitting unit.

In the pixel unit of the disclosure, the color of the first light emitting unit is the same as the color of the second light emitting unit.

In the pixel unit of the disclosure, the pixel unit further comprises a third region. The third region comprises a third driving circuit and a third light emitting unit, and the third driving circuit is electrically connected to the third light emitting unit. A structure of the third driving circuit is the same as a structure of the first driving circuit or the second driving circuit.

In the pixel unit of the disclosure, the colors of the first light emitting unit, the second light emitting unit and the third light emitting unit are the same.

In the pixel unit of the disclosure, the pixel unit further comprises a fourth light emitting unit. The fourth light emitting unit is disposed in the first region or the second region, the color of the fourth light emitting unit is the same as the color of the light emitting unit in a corresponding region.

In the pixel unit of the disclosure, the fourth light emitting unit is disposed in the first region. A first driving circuit is electrically connected to the fourth light emitting unit, and the first driving circuit is configured to drive the first light emitting unit and the fourth light emitting unit to emit light; or the fourth light emitting unit is disposed in the second region, the second driving circuit is electrically connected to the fourth light emitting unit, and the second driving circuit is configured to drive the second light emitting unit and the fourth light emitting unit to emit light.

The disclosure further provides a display panel. The display panel comprises a pixel unit. The pixel unit at least comprises a first region and a second region;

wherein at least a first light emitting unit is disposed in the first region;

at least a second light emitting unit is disposed in the second region; and

wherein when the pixel unit is in an operating state, one of the first light emitting unit and the second light emitting unit is in a light emitting state.

In the display panel of the disclosure, the first region further comprises a first driving circuit, and the first driving circuit is electrically connected to the first light emitting unit; the second region further comprises a second driving circuit, and the second driving circuit is electrically connected to the second light emitting unit. When the pixel unit is in the operating state, the first driving circuit is configured to drive the first light emitting unit to emit light, or the second driving circuit is configured to drive the second light emitting unit to emit light.

In the display panel of the disclosure, the first driving circuit at least comprises a first thin film transistor, a second thin film transistor, and a first storage capacitor; the second driving circuit at least comprises a third thin film transistor, a fourth thin film transistor, and a second storage capacitor. The first thin film transistor, the second thin film transistor, the third thin film transistor, and the fourth thin film transistor are one of a P-type transistor or an N-type transistor. A transistor type of the fourth thin film transistor is different from transistor types of the first thin film transistor, the second thin film transistor, and the third thin film transistor.

In the display panel of the disclosure, a gate of the first thin film transistor is electrically connected to a scanning signal line, a source/drain of the first thin film transistor is electrically connected to a data signal line, and a drain/source of the first thin film transistor is electrically connected to a first electrode plate of the first storage capacitor and a gate of the second thin film transistor; a source/drain of the second thin film transistor is electrically connected to an input terminal of the pixel unit, and a drain/source of the second thin film transistor is electrically connected to a second electrode plate of the first storage capacitor and the first light emitting unit. A gate of the third thin film transistor is electrically connected to a scanning signal line, a source/drain of the third thin film transistor is electrically connected to a data signal line, and a drain/source of the first thin film transistor is electrically connected to the first electrode plate of the second storage capacitor and the gate of the second thin film transistor; a source/drain of the fourth thin film transistor is electrically connected to the input terminal of the pixel unit and is electrically connected to the second electrode plate of the second storage capacitor, and a drain/source of the fourth thin film transistor is connected to the second light emitting unit.

In the display panel of the disclosure, the color of the first light emitting unit is the same as the color of the second light emitting unit.

In the pixel unit of the disclosure, the pixel unit further comprises a third region. The third region comprises a third driving circuit and a third light emitting unit, and the third driving circuit is electrically connected to the third light emitting unit. A structure of the third driving circuit is the same as a structure of the first driving circuit or the second driving circuit.

In the display panel of the disclosure, the colors of the first light emitting unit, the second light emitting unit and the third light emitting unit are the same.

In the display panel of the disclosure, the pixel unit further comprises a fourth light emitting unit. The fourth light emitting unit is disposed in the first region or the second region, the color of the fourth light emitting unit is the same as the color of the light emitting unit in a corresponding region.

In the display panel of the disclosure, the fourth light emitting unit is disposed in the first region. A first driving circuit is electrically connected to the fourth light emitting unit, and the first driving circuit is configured to drive the first light emitting unit and the fourth light emitting unit to emit light; or the fourth light emitting unit is disposed in the second region, the second driving circuit is electrically connected to the fourth light emitting unit, and the second driving circuit is configured to drive the second light emitting unit and the fourth light emitting unit to emit light.

The technical effects are as follows. In the pixel unit and the display panel of the disclosure, at least two light emitting units are disposed in one pixel unit, one light emitting unit corresponds to one driving circuit, and the first light emitting unit and the second light emitting unit can operate interactively by inputting different driving signals to the pixel unit. Therefore, the service lifespan of the organic light emitting diodes and the thin film transistors is prolonged, and the technical problems such as the afterimage of the conventional display panel are prevented.

### DESCRIPTION OF DRAWINGS

In order to clearly illustrate the embodiments of the present disclosure or the technical solutions in the prior art, the following briefly introduces the accompanying drawings used in the embodiments. Obviously, the drawings in the following description merely show some of the embodiments of the present disclosure. As regards one of ordinary skill in the art, other drawings can be obtained in accordance with these accompanying drawings without making creative efforts.

FIG. 1 is a schematic diagram of a first circuit structure of a pixel unit of the disclosure.

FIG. 2 is a timing control schematic diagram of the driving circuit of the pixel unit of the disclosure.

FIG. 3 is a schematic diagram of a second circuit structure of a pixel unit of the disclosure.

FIG. 4 is a schematic diagram of a third circuit structure of a pixel unit of the disclosure.

### DETAILED DESCRIPTION OF PREFERRED EMBODIMENTS

This description of the exemplary embodiments is intended to be read in connection with the accompanying drawings, which are to be considered part of the entire written description. In the description, terms such as “lower”, “upper”, “front”, “behind”, “left”, “right”, “inside”, “outside”, and “side”, as well as derivatives thereof, should be construed to refer to the orientation as then described or as shown in the drawing under discussion. The elements mentioned in the disclosure, such as the first, second, etc., are only to better distinguish and express different components. Referring to the drawings of the disclosure, similar elements are labeled with the same number.

As the conventional display panel emits light for a long time, the OLED elements of the display panel will gradually decay or/and a threshold voltage of a TFT device drifts, resulting in afterimages in the display panel and reducing the quality of the display panel.

The disclosure provides a pixel unit. The pixel unit at least comprises a first region and a second region. At least a first light emitting unit is disposed in the first region, and at least a second light emitting unit is disposed in the second region. When the pixel unit is in an operating state, one of the first light emitting unit and the second light emitting unit is in a light emitting state.

In the disclosure, at least two light emitting units are disposed in one pixel unit. The colors of the two light emitting units may be the same or different, and the colors may be arranged according to the corresponding driving circuit in the specific embodiment. The light emitting units in one pixel unit can operate interactively, so that the service lifespan of the organic light emitting diodes and the thin film transistors is prolonged, and the technical problems, such as the afterimage of the conventional display panel are prevented.

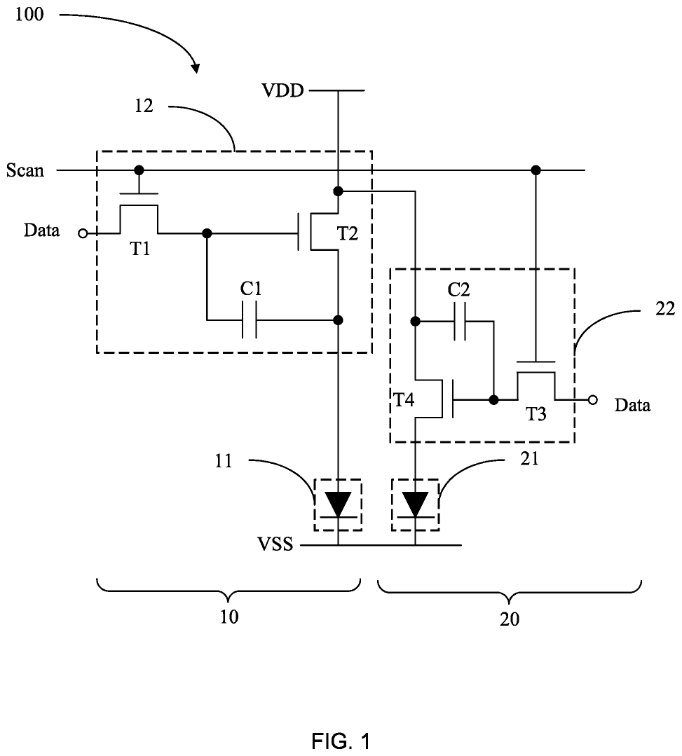

Referring to FIG. 1, a schematic diagram of a first circuit structure of a pixel unit of the disclosure is shown.

The pixel unit at least comprises a first region 10 and a second region 20.

A first driving circuit 12 and a first light emitting unit 11 disposed on the first driving circuit 12 are disposed in the first region 10. The first driving circuit 12 is electrically connected to the first light emitting unit 11. The first driving circuit 12 is configured to drive the first light emitting unit 11 to emit light.

A second driving circuit 22 and a second light emitting unit 21 disposed on the second driving circuit 22 are disposed in the second region 20. The second driving circuit 22 is electrically connected to the second light emitting unit 21. The second driving circuit 22 is configured to drive the second light emitting unit 21 to emit light.

In an embodiment, when the pixel unit is in an operating state, the first driving circuit 12 is configured to drive the first light emitting unit 11 to emit light, or the second driving circuit 22 is configured to drive the second light emitting units 21 to emit light.

The first light emitting unit 11/the second light emitting unit 21 operate interactively in the pixel unit through the first driving circuit 12/the second driving circuit 22. The service life of the first light emitting unit 11, the second light emitting unit 21, the first driving circuit 12, and the second driving circuit 22 is prolonged.

In one embodiment, the first driving circuit 12 at least comprises a first thin film transistor T1, a second thin film transistor T2, and a first storage capacitor C1. The second driving circuit 22 at least comprises a third thin film transistor T3, a fourth thin film transistor T4, and a second storage capacitor C2.

Referring to FIG. 1, the driving circuit of the disclosure uses a simple 2T1C (two thin film transistors and one storage capacitor) as an example for description.

The first thin film transistor T1, the second thin film transistor T2, the third thin film transistor T3, and the fourth thin film transistor T4 in this disclosure are one of a P-type transistor or an N-type transistor.

In one embodiment, the transistor type of the fourth thin film transistor T4 is different from the first thin film transistor T1, the second thin film transistor T2, and the third thin film transistor T3. In the embodiment of the disclosure, the first thin film transistor T1, the second thin film transistor T2, the third thin film transistor T3 are N-type transistors, and the fourth thin film transistor T4 is a P-type transistor.

Referring to FIG. 1, a gate of the first thin film transistor T1 is electrically connected to a scanning signal line, a source/drain of the first thin film transistor T1 is electrically connected to a data signal line, and a drain/source of the first thin film transistor T1 is electrically connected to a first electrode plate of the first storage capacitor C1 and is electrically connected to a gate of the second thin film transistor T2.

A source/drain of the second thin film transistor T2 is electrically connected to an input terminal of the pixel unit, and a drain/source of the second thin film transistor T2 is electrically connected to a second electrode plate of the first storage capacitor C1 and is electrically connected to the first light emitting unit 11.

A gate of the third thin film transistor T3 is electrically connected to a scanning signal line, a source/drain of the third thin film transistor T3 is electrically connected to a data signal line, and a drain/source of the first thin film transistor T1 is electrically connected to a first electrode plate of the second storage capacitor C2 and is electrically connected to the gate of the second thin film transistor T2.

A source/drain of the fourth thin film transistor T4 is electrically connected to an input terminal of the pixel unit and is electrically connected to a second electrode plate of the second storage capacitor C2. A drain/source of the fourth thin film transistor T4 is electrically connected to the second light emitting unit 21.

In one embodiment, the first light emitting unit 11 and the second light emitting unit 21 are organic light emitting diodes. The anode of the first light emitting unit 11 is electrically connected to the source/drain of the second thin film transistor T2 and is electrically connected to the second electrode plate of the first storage capacitor C1. The anode of the second light emitting unit 21 is electrically connected to the source/drain of the fourth thin film transistor T4, and the cathode of the first light emitting unit 11 and the second light emitting unit 21 is electrically connected to a constant-voltage low-level source VSS.

In one embodiment, the colors of the first light emitting unit 11 and the second light emitting unit 21 are the same.

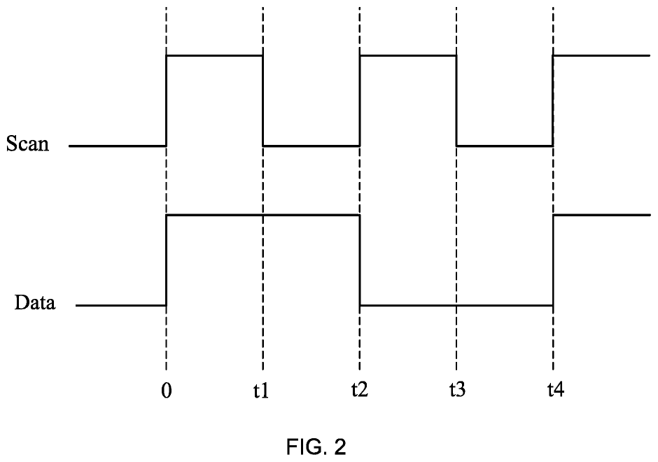

Referring to FIG. 2, a timing control schematic diagram of the driving circuit of the pixel unit of the disclosure is shown.

A period in the timing control schematic diagram includes four periods: 0 to T1, T1 to T2, T2 to T3, and T3 to T4. Different voltage signals are input from data signal lines and scanning signal lines in different periods.

The scanning signal line and the data signal line output high-level signals in the period of 0 to T1.

In this embodiment, the gate of the first thin film transistor T1 is electrically connected to the scanning signal line. Since the first thin film transistor T1 is an N-type transistor, a high-level signal is input to the scanning signal line to turn on a switch of the first thin film transistor T1, and a high-level signal input from the data signal line is input from a source of the first thin film transistor T1 to a drain of the first thin film transistor T1, and is transmitted to the gate of the second thin film transistor T2 and the first electrode plate of the first storage capacitor C1.

Since the second thin film transistor T2 is an N-type thin film transistor, a high-level signal transmitted from the first thin film transistor T1 causes the switch of the second thin film transistor T2 to be turned on. The constant-voltage high-level source VDD of the pixel unit is input to the drain of the second thin film transistor T2 through the source of the second thin film transistor T2, and is transmitted to the second electrode plate of the first storage capacitor C1 and the anode of the first light emitting unit 11. The first storage capacitor C1 is in a charging state. The cathode of the first light emitting unit 11 is connected to a constant-voltage low-level source, so that the first light emitting unit 11 emits light during a period of 0 to t1.

The gate of the third thin film transistor T3 receives a high-level signal output from the scanning signal line. Since the third thin film transistor T3 is an N-type transistor, the switch of the third thin film transistor T3 is turned on, and the high-level signal input from the data signal line is input from a source of the third thin film transistor T3 to a drain of the third thin film transistor T3, and is transmitted to a gate of the fourth thin film transistor T4. Since the fourth thin film transistor T4 is a P-type transistor, the high-level signal cannot turn on the switch of the fourth thin film transistor T4. Therefore, the second light emitting unit 21 does not emit light during a period of 0 to t1.

During the period of t1 to t2, the scanning signal line outputs a low-level signal, and the data signal line outputs a high-level signal.

In this embodiment, the gate of the first thin film transistor T1 is electrically connected to the scanning signal line. Since the first thin film transistor T1 is an N-type transistor, a low-level signal input from the scanning signal line cannot turn on the switch of the first thin film transistor T1, and a signal output from the data signal line cannot be transmitted to the second thin film transistor T2. At this time, the first storage capacitor C1 is in a discharging state, the high-level signal released by the first storage capacitor C1 turns on the second thin film transistor T2. The constant-voltage high-level source VDD of the pixel unit is input to a drain of the second thin film transistor T2 through a source of the second thin film transistor T2, and is transmitted to the anode of the first light emitting unit 11. The cathode of the first light emitting unit 11 is connected to a constant-voltage low-level source, so that the first light emitting unit 11 emits light during a period of t1 to t2.

Since the scan signal line outputs a low-level signal, the switch of the third thin film transistor T3 cannot be turned on. In the period of 0 to t1, the second storage capacitor C2 is not charged, so that the second light emitting unit 21 does not emit light during the period of t1 to t2.

During the period of t2 to t3, the scanning signal line outputs a high-level signal, and the data signal line outputs a low-level signal.

In this embodiment, the gate of the first thin film transistor T1 is electrically connected to the scanning signal line. Since the first thin film transistor T1 is an N-type transistor, a low-level signal input from the scanning signal line cannot turn on the switch of the first thin film transistor T1. A signal output from the data signal line cannot be transmitted to the second thin film transistor T2. No capacitance is released from the first storage capacitor C1, and the second thin film transistor T2 is in an off state. Thus, the constant-voltage high-level source VDD of the pixel unit cannot be transmitted to the anode of the first light emitting unit 11. Therefore, the first light emitting unit 11 does not emit light during a period from t2 to t3.

The gate of the third thin film transistor T3 is electrically connected to the scanning signal line. Since the third thin film transistor T3 is an N-type transistor, a high-level signal input from the scanning signal line turns on the switch of the transistor T3. A low-level signal input from the data signal line is input from the source of the third thin film transistor T3 to the drain of the third thin film transistor T3 and is transmitted to the fourth thin film transistor T4 and a first electrode plate of the second storage capacitor C2.

Since the fourth thin film transistor T4 is a P-type thin film transistor, a low-level signal transmitted from the third thin film transistor T3 causes the switch of the fourth thin film transistor T4 to be turned on, and the constant-voltage high-level source VDD of the pixel unit is input to the drain of the second thin film transistor T2 through the source of the second thin film transistor T2, and is transmitted to the second electrode plate of the second storage capacitor C2 and the anode of the second light emitting unit 21. The second storage capacitor C2 is in a charging state. The cathode of the second light emitting unit 21 is connected to a constant-voltage low-level source, so that the second light emitting unit 21 emits light during a period of t2 to t3.

During the period of t3 to t4, the scanning signal line and the data signal line output low-level signals.

In this embodiment, the gate of the third thin film transistor T3 is electrically connected to the scanning signal line. Since the third thin film transistor T3 is an N-type transistor, a low-level signal input from the scanning signal line cannot turn on the switch of the first thin film transistor T1, and the signal output from the data signal line cannot be transmitted to the second thin film transistor T2. At this time, the second storage capacitor C2 is in a discharging state, and the low-level signal released by the second storage capacitor C2 turns on the fourth thin film transistor T4. The constant-voltage high-level source VDD of the pixel unit is input to the drain of the fourth thin-film transistor T4 through the source of the fourth thin-film transistor T4 and is transmitted to the anode of the second light emitting unit 21. The cathode of the second light emitting unit 21 is connected to a constant-voltage low-level source. Therefore, the second light emitting unit 21 emits light during a period of t3 to t4.

Since the scanning signal line outputs a low-level signal, the switch of the first thin film transistor T1 cannot be turned on. In the period of t2 to t3, the first storage capacitor C1 is not charged, so that the first light emitting unit 11 does not emit light during the period of t3 to t4.

In one embodiment, the pixel unit further includes a third region 30.

A third driving circuit 32 and a third light emitting unit 31 are disposed in the third region 30. The third driving circuit 32 is electrically connected to the third light emitting unit 31. The third driving circuit 32 is configured to drive the third light emitting unit 31 to emit light.

In one embodiment, the structure of the third driving circuit 32 is the same as that of the first driving circuit 12 or the second driving circuit 22.

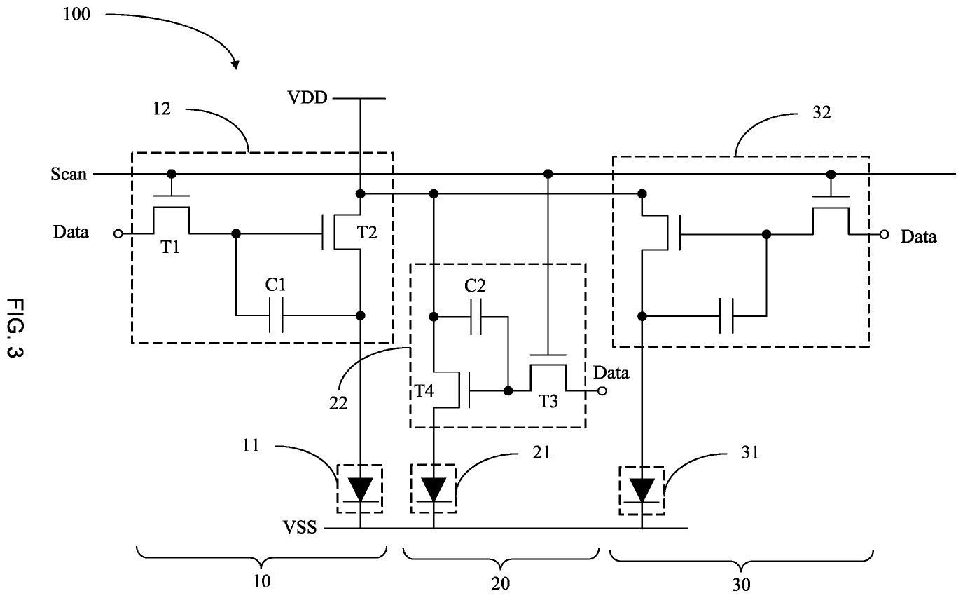

Referring to FIG. 3, a schematic diagram of a second circuit structure of a pixel unit of the disclosure is shown.

The structure of the third driving circuit 32 is the same as that of the first driving circuit 12.

During the period of 0 to t1, the scanning signal line and the data signal line output high-level signals. The first light emitting unit 11 and the third light emitting unit 31 emit light, and the second light emitting unit 21 does not emit light.

During the period of t1 to t2, the scanning signal line outputs a low-level signal, and the data signal line outputs a high-level signal. The first light emitting unit 11 and the third light emitting unit 31 emit light, and the second light emitting unit 21 does not emit light.

During the period of t2 to t3, the scanning signal line outputs a high-level signal, and the data signal line outputs a low-level signal. The first light emitting unit 11 and the third light emitting unit 31 do not emit light, and the second light emitting unit 21 emits light.

During the period of t3 to t4, the scanning signal line and the data signal line output low-level signals. The first light emitting unit 11 and the third light emitting unit 31 do not emit light, and the second light emitting unit 21 emits light.

In one embodiment, the colors of the first light emitting unit 11, the second light emitting unit 21, and the third light emitting unit 31 are the same.

In one embodiment, the pixel unit further includes a fourth light emitting unit 13.

The fourth light emitting unit 13 is disposed in the first region 10 or the second region 20.

The fourth light emitting unit 13 is disposed in the first region 10. The first driving circuit 12 is electrically connected to the fourth light emitting unit 13. The first driving circuit 12 is configured to drive the first light emitting unit 11 and the fourth light emitting unit 13 to emit light.

Alternatively, the fourth light emitting unit 13 is disposed in the second region 20, and a second driving circuit 22 is electrically connected to the fourth light emitting unit 13. The second driving circuit 22 is configured to drive the second light emitting unit 21 and the fourth light emitting unit 13 to emit light.

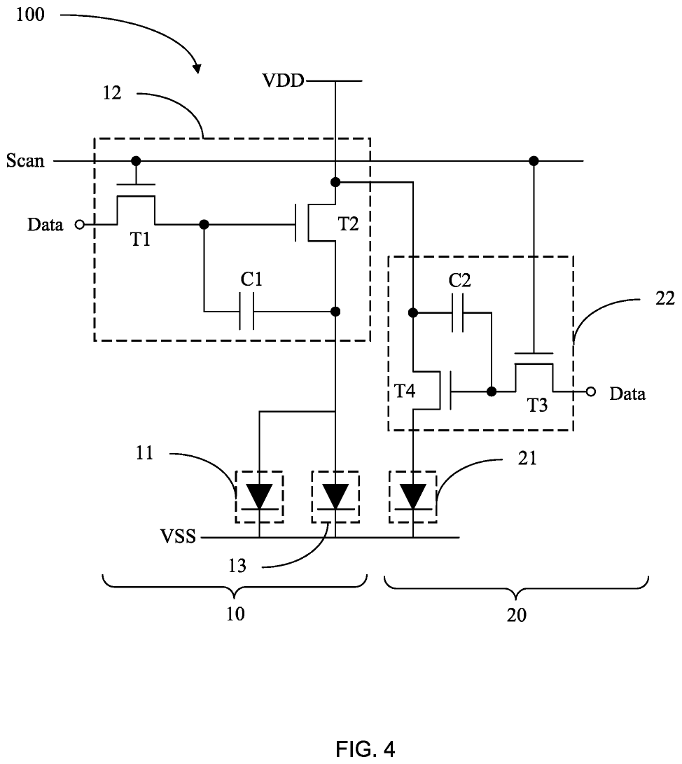

Referring to FIG. 4, a schematic diagram of a third circuit structure of a pixel unit of the disclosure is shown.

The fourth light emitting unit 13 is disposed in the first region 10. The first driving circuit 12 controls the first light emitting unit 11 and the fourth light emitting unit 13 simultaneously.

In one embodiment, the color of the fourth light emitting unit 13 is the same as the color of the light emitting unit in a corresponding region.

During the period of 0 to t1, and t1 to t2, the first light emitting unit 11 and the fourth light emitting unit 13 emit light. During the period of t2 to t3, and t3 to t4, the second light emitting unit 21 emits light. Therefore, a light emission brightness of a display device during the period of 0 to t2 is greater than a light emission brightness of the display device during the period of t2 to t4. When the display device is in a dark-light environment, the pixel unit can be controlled to be in the period of t2 to t4. When the display device is in a strong light environment, the pixel unit can be controlled to be in the period of 0 to t2.

The disclosure further provides a display panel including the above-mentioned pixel unit. The operation principle of the display panel is the same as or similar to the above-mentioned pixel unit, and is not described herein.

The disclosure provides a pixel unit and a display panel. The pixel unit at least comprises a first region and a second region. At least a first light emitting unit is disposed in the first region, and at least a second light emitting unit is disposed in the second region. When the pixel unit is in an operating state, one of the first light emitting unit and the second light emitting unit is in a light emitting state. In the pixel unit and the display panel of the disclosure, at least two light emitting units are disposed in one pixel unit, one light emitting unit corresponds to one driving circuit, and the first light emitting unit and the second light emitting unit can operate interactively by inputting different driving signals to the pixel unit. Therefore, the service lifespan of the organic light emitting diodes and the thin film transistors is prolonged, and the technical problems, such as the afterimage of the conventional display panel are prevented.

This disclosure has been described with preferred embodiments thereof, and it is understood that many changes and modifications to the described embodiment can be carried out without departing from the scope and the spirit of the invention that is intended to be limited only by the appended claims.

What is claimed is:

1. A pixel unit, at least comprising: a first region and a second region;
wherein at least a first light emitting unit is disposed in the first region;
at least a second light emitting unit is disposed in the second region; and
wherein when the pixel unit is in an operating state, one of the first light emitting unit and the second light emitting unit is in a light emitting state.

2. The pixel unit according to claim 1, wherein the first region further comprises a first driving circuit, and the first driving circuit is electrically connected to the first light emitting unit;
the second region further comprises a second driving circuit, and the second driving circuit is electrically connected to the second light emitting unit; and
wherein when the pixel unit is in the operating state, the first driving circuit is configured to drive the first light emitting unit to emit light, or the second driving circuit is configured to drive the second light emitting unit to emit light.

3. The pixel unit according to claim 2, wherein the first driving circuit at least comprises a first thin film transistor, a second thin film transistor, and a first storage capacitor;
the second driving circuit at least comprises a third thin film transistor, a fourth thin film transistor, and a second storage capacitor; and
wherein the first thin film transistor, the second thin film transistor, the third thin film transistor, and the fourth thin film transistor are one of a P-type transistor or an N-type transistor; and
wherein a transistor type of the fourth thin film transistor is different from transistor types of the first thin film transistor, the second thin film transistor, and the third thin film transistor.

4. The pixel unit according to claim 3, wherein a gate of the first thin film transistor is electrically connected to a scanning signal line, a source/drain of the first thin film transistor is electrically connected to a data signal line, and a drain/source of the first thin film transistor is electrically connected to a first electrode plate of the first storage capacitor and a gate of the second thin film transistor;
a source/drain of the second thin film transistor is electrically connected to an input terminal of the pixel unit, and a drain/source of the second thin film transistor is electrically connected to a second electrode plate of the first storage capacitor and the first light emitting unit;
a gate of the third thin film transistor is electrically connected to a scanning signal line, a source/drain of the third thin film transistor is electrically connected to a data signal line, and a drain/source of the first thin film transistor is electrically connected to the first electrode plate of the second storage capacitor and the gate of the second thin film transistor;
a source/drain of the fourth thin film transistor is electrically connected to the input terminal of the pixel unit and is electrically connected to the second electrode plate of the second storage capacitor, and a drain/source of the fourth thin film transistor is connected to the second light emitting unit.

5. The pixel unit according to claim 1, wherein the color of the first light emitting unit is the same as the color of the second light emitting unit.

6. The pixel unit according to claim 1, wherein the pixel unit further comprises a third region;
the third region comprises a third driving circuit and a third light emitting unit, and the third driving circuit is electrically connected to the third light emitting unit;
a structure of the third driving circuit is the same as a structure of the first driving circuit or the second driving circuit.

7. The pixel unit according to claim 6, wherein the colors of the first light emitting unit, the second light emitting unit and the third light emitting unit are the same.

8. The pixel unit according to claim 1, wherein the pixel unit further comprises a fourth light emitting unit;
the fourth light emitting unit is disposed in the first region or the second region;
the color of the fourth light emitting unit is the same as the color of the light emitting unit in a corresponding region.

9. The pixel unit according to claim 8, wherein
the fourth light emitting unit is disposed in the first region;
a first driving circuit is electrically connected to the fourth light emitting unit, and the first driving circuit is configured to drive the first light emitting unit and the fourth light emitting unit to emit light; or
the fourth light emitting unit is disposed in the second region;
the second driving circuit is electrically connected to the fourth light emitting unit, and the second driving circuit is configured to drive the second light emitting unit and the fourth light emitting unit to emit light.

10. A display panel, comprising: a pixel unit;
wherein the pixel unit at least comprises a first region and a second region;
at least a first light emitting unit is disposed in the first region;
at least a second light emitting unit is disposed in the second region; and
wherein when the pixel unit is in an operating state, one of the first light emitting unit and the second light emitting unit is in a light emitting state.

11. The display panel according to claim 10, wherein the first region further comprises a first driving circuit, and the first driving circuit is electrically connected to the first light emitting unit;
the second region further comprises a second driving circuit, and the second driving circuit is electrically connected to the second light emitting unit; and
wherein when the pixel unit is in the operating state, the first driving circuit is configured to drive the first light emitting unit to emit light, or the second driving circuit is configured to drive the second light emitting unit to emit light.

12. The display panel according to claim 11, wherein the first driving circuit at least comprises a first thin film transistor, a second thin film transistor, and a first storage capacitor;
the second driving circuit at least comprises a third thin film transistor, a fourth thin film transistor, and a second storage capacitor; and
wherein the first thin film transistor, the second thin film transistor, the third thin film transistor, and the fourth thin film transistor are one of a P-type transistor or an N-type transistor; and
wherein a transistor type of the fourth thin film transistor is different from transistor types of the first thin film transistor, the second thin film transistor, and the third thin film transistor.

13. The display panel according to claim 12, wherein a gate of the first thin film transistor is electrically connected to a scanning signal line, a source/drain of the first thin film transistor is electrically connected to a data signal line, and a drain/source of the first thin film transistor is electrically connected to a first electrode plate of the first storage capacitor and a gate of the second thin film transistor;
a source/drain of the second thin film transistor is electrically connected to an input terminal of the pixel unit, and a drain/source of the second thin film transistor is electrically connected to a second electrode plate of the first storage capacitor and the first light emitting unit;
a gate of the third thin film transistor is electrically connected to a scanning signal line, a source/drain of the third thin film transistor is electrically connected to a data signal line, and a drain/source of the first thin film transistor is electrically connected to the first electrode plate of the second storage capacitor and the gate of the second thin film transistor;
a source/drain of the fourth thin film transistor is electrically connected to the input terminal of the pixel unit and is electrically connected to the second electrode plate of the second storage capacitor, and a drain/source of the fourth thin film transistor is connected to the second light emitting unit.

14. The display panel according to claim 10, wherein the color of the first light emitting unit is the same as the color of the second light emitting unit.

15. The display panel according to claim 10, wherein the pixel unit further comprises a third region;
the third region comprises a third driving circuit and a third light emitting unit, and the third driving circuit is electrically connected to the third light emitting unit;
a structure of the third driving circuit is the same as a structure of the first driving circuit or the second driving circuit.

16. The display panel according to claim 15, wherein the colors of the first light emitting unit, the second light emitting unit and the third light emitting unit are the same.

17. The display panel according to claim 10, wherein the pixel unit further comprises a fourth light emitting unit;
the fourth light emitting unit is disposed in the first region or the second region;
the color of the fourth light emitting unit is the same as the color of the light emitting unit in a corresponding region.

18. The display panel according to claim 17, wherein
the fourth light emitting unit is disposed in the first region;
a first driving circuit is electrically connected to the fourth light emitting unit, and the first driving circuit is configured to drive the first light emitting unit and the fourth light emitting unit to emit light; or
the fourth light emitting unit is disposed in the second region;
the second driving circuit is electrically connected to the fourth light emitting unit, and the second driving circuit is configured to drive the second light emitting unit and the fourth light emitting unit to emit light.
